(19) United States
(12) Patent Application Publication
(10) Pub. No.: US 2026/0253121 A1
(43) Pub. Date: Aug. 27, 2026

(54) GENERATING LISTING INSIGHTS WITH ARTIFICIAL INTELLIGENCE

(71) Applicant: eBay Inc., San Jose, CA (US)

(72) Inventors: Anirban Ghosh, Newark, CA (US); Rupashi Sangal, San Jose, CA (US); Bindia Saraf, Sunnyvale, CA (US)

(73) Assignee: eBay Inc., San Jose, CA (US)

(21) Appl. No.: 19/065,717

(22) Filed: Feb. 27, 2025

(51) Int. Cl. G06Q 30/0601; G06Q 30/0283

(52) U.S. Cl. CPC G06Q 30/0631; G06Q 30/0283

(57) ABSTRACT

In the implementation of techniques for generating listing insights with artificial intelligence, a system receives item data corresponding to an item. The system extracts item attributes from the item data. Based on the item attributes, the system generates an item embedding representing the item attributes. Based on the item embedding, the system generates relevance scores for item listings, wherein each relevance score represents a relevance between the item embedding and item listing embeddings corresponding to the item listings. The system initiates retrieval of item listing data including attribute data of relevant item listings based on each of the relevant item listings having a relevance score exceeding a threshold amount. Based on the attribute data of the relevant item listings, the system generates a listing insight for the item. The system broadcasts the listing insight for display.

### BACKGROUND

Conventional techniques for generating listing insights often face challenges with scalability, data quality, and adaptability. The conventional techniques fail to effectively process the vast and ever-growing volume of data generated by online listing platforms, because the conventional techniques generally rely on manual analysis or rule-based systems that are not configured to handle such complexity.

Additionally, listings often contain unstructured or inconsistent data, such as varying formats, which the conventional techniques are poorly equipped to standardize and interpret. Accordingly, the conventional techniques result in limited listing insight generation, with analyses often confined to predefined rules or basic statistical summaries, leaving nuanced patterns and emerging trends unsurfaced. Furthermore, the conventional techniques are often static and lack personalization, generating generalized insights that fail to cater to distinct users or contexts.

The conventional techniques are also slow to adapt to evolving conditions of the online listing platforms, as predefined rules and manual updates are not configured to keep pace with evolving user behaviors or sudden listing trends. Fragmentation across the online listing platforms further compounds the problem, because aggregating and analyzing the fragmented data holistically is a significant technical hurdle.

### SUMMARY

Techniques and systems for generating listing insights with artificial intelligence are described. In an example, a computing device receives item data corresponding to an item. The computing device extracts one or more item attributes from the item data. Based on the one or more item attributes, the computing device generates an item embedding representing the one or more item attributes extracted.

Based on the item embedding, the computing device generates one or more relevance scores for a plurality of item listings, wherein each of the one or more relevance scores is representative of a relevance between the item embedding and item listing embeddings corresponding to the plurality of item listings. The computing device initiates retrieval of one or more relevant item listings based on each of the one or more relevant item listings being associated with a relevance score exceeding a threshold amount, wherein the each of the one or more relevant item listings includes attribute data. Based on the attribute data, the computing device generates a listing insight for the item. Responsive to the generating of the listing insight, the computing device automatically modifies an item listing in accordance with the listing insight.

The disclosed techniques and systems enable efficient techniques for generating listing insights with artificial intelligence without the limited scalability, adaptability, and personalization that results from the conventional techniques.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ techniques and systems for generating listing insights with artificial intelligence as described herein.

FIG. 2 depicts a system 200 in an example implementation showing operation of the listing insight management system for generating the listing insight.

FIG. 3 depicts a system in an example implementation showing operation of the listing insight management system for generating modified listing attribute based on the listing insight.

FIG. 4 depicts a system in an example implementation showing operation of the listing insight management system for training one or more artificial intelligence models based at least in part on item listing data.

FIG. 5 depicts an example implementation of a user interface configured to receive item data via user input and to generate a listing insight based on the item data.

FIG. 6 depicts an example implementation of a user interface configured to generate a modified listing attribute as part of an item listing based on the listing insight.

FIG. 7 depicts an example implementation of a user interface configured to automatically generate a listing insight responsive to detecting a predefined condition.

FIG. 8 depicts a procedure in an example implementation of generating listing insights with artificial intelligence.

FIG. 9 illustrates an example system including various components of an example device that can be implemented as any type of computing device as described and/or utilized with reference to FIGS. 1-8 to implement examples of the techniques described herein.

### DETAILED DESCRIPTION

### Overview

Conventional techniques for generating listing insights result in inefficiencies such as inefficient processing times, limited scalability, limited adaptability to evolving or real-time listing trends, and ineffectiveness at generating personalized insights. These conventional techniques, which are characterized by reliance on manual processes, static rule-based techniques, and limited ability to leverage diversely structured data, fail to efficiently adapt to dynamic or real-time listing conditions or uncover listing insights in large-scale datasets of diversely structured data.

Techniques for generating listing insights with artificial intelligence are described that overcome these limitations. For instance, consider an example in which a computing device receives item data corresponding to a smartphone. A user provides user input to the computing device via a user interface, specifying details about the smartphone, such as a pink new SmoFo 2024 with 1 TB of storage. This information is processed as the item data. The computing device extracts attributes from the item data, such as the model (SmoFo 2024), color (pink), storage capacity (1 TB), and condition (new).

The computing device uses these attributes to generate an item embedding, a representation (e.g., a vector representation) encoding the attributes of the SmoFo 2024. The computing device compares the item embedding against embeddings for a plurality of existing smartphone listings. Based on these comparisons, the computing device generates relevance scores for each existing smartphone listing, which measure a relevance (e.g., a similarity) between the SmoFo 2024 and other existing smartphone listings.

The computing device retrieves real-time data corresponding to the existing smartphone listings with relevance scores exceeding a threshold (e.g., a predefined threshold), and the computing device analyzes the real-time data. Based on the real-time data, the computing device generates a listing insight for the SmoFo 2024, such as a pricing insight. Based on the listing insight, the computing device communicates the pricing insight for display.

The described techniques for generating the listing insights with artificial intelligence ensure that item listings are effectively structured, reducing inefficient manual effort and enhancing scalability. These adaptive techniques enable real-time, data-driven adjustments to item listings, thereby enhancing the accuracy and effectiveness of listing attribute decisions. Therefore, the described techniques for generating the listing insights with artificial intelligence effectively handle large-scale, diversely structured data, and dynamically adapt to evolving listing conditions, resolving the scalability, data inconsistency, and static analysis issues caused by the conventional techniques.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

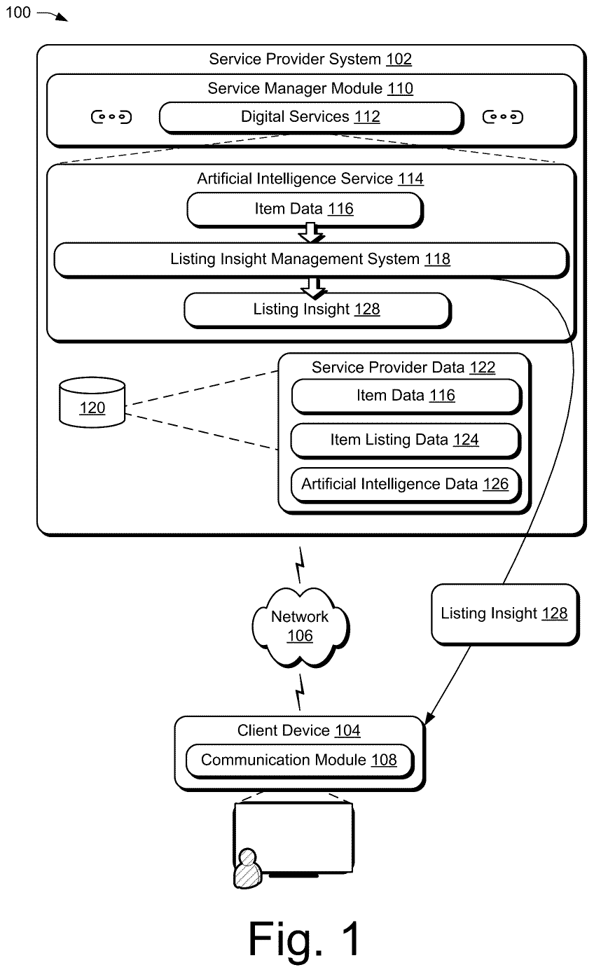

FIG. 1 is an illustration of a digital medium environment 100 in an example implementation that is operable to employ techniques and systems for generating listing insights with artificial intelligence.

The illustrated environment 100 includes a service provider system 102 and a client device 104 that are communicatively coupled, one to another, via a network 106. Computing devices that implement the service provider system 102 and the client device 104 are configurable in a variety of ways.

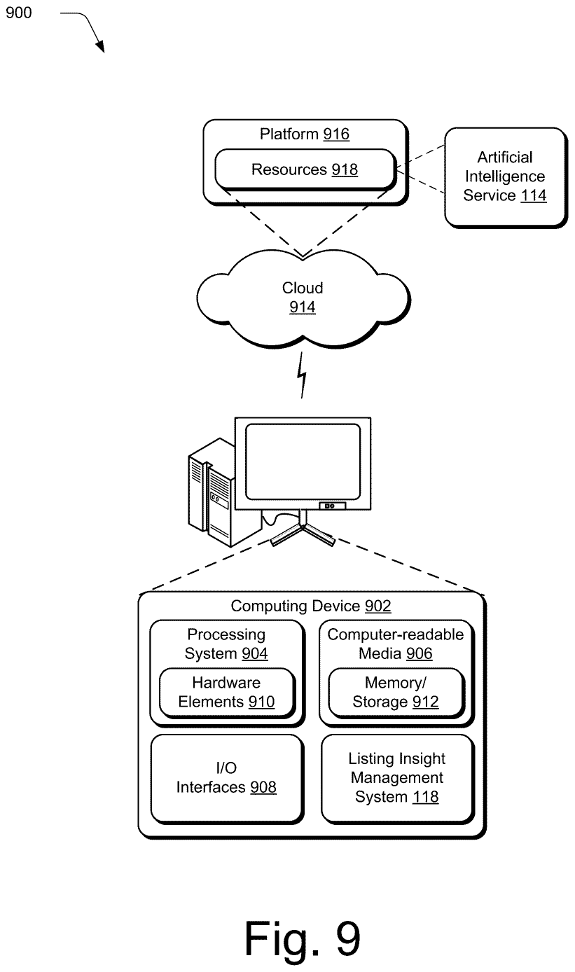

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is described in some examples, a computing device is also representative of a plurality of different devices, such as multiple servers utilized by a business to perform operations “over the cloud” as described in FIG. 9.

The client device 104 includes a communication module 108 that is representative of functionality to communicate via the network 106 with a service manager module 110 of the service provider system 102. The service manager module 110 is representative of functionality to implement digital services 112. Examples of the digital services 112 include cloud storage, data analytics, APIs for integrating external applications, and listing insight generation services. The digital services 112 are usable to expose a variety of functionality to the client device 104, an example of which is illustrated as an artificial intelligence service 114.

The artificial intelligence service 114 is configured to manage artificial intelligence content based on received inputs. The artificial intelligence service 114, for instance, can generate, train, and deploy one or more artificial intelligence models, communicate with them, and generate listing insights at least in part via the one or more artificial intelligence models. In the illustrated example, the artificial intelligence service 114 employs item data 116. The item data 116 includes data pertaining to items made available via item listings. The item listings are made available by various sources, examples of which include the service provider system 102, other service provider systems, one or more online listing platforms, and so forth. Examples of the item data 116 include data such as descriptions of the item, digital content (e.g., images, videos, audio, etc.) corresponding to the item, item model, item color, item name, item year, item condition, item price, item owner, and item metadata, item edition, item category, or item specifications.

The artificial intelligence service 114 includes a listing insight management system 118 that is configured for managing deployment of listing insights 128 and artificial intelligence resources available for the listing insights 128. The listing insights 128 represent digital content representative of data-driven insights (e.g., recommendations) corresponding to an item. The listing insight management system 118, in some instances, generates the listing insights 128 based on the item data 116.

Examples of the listing insights 128 include pricing insights, such as price recommendations and dynamic price adjustments based on market trends, or item demand forecasting, predicting item demand. Examples of the listing insight 128 include performance insights, offering insights for improving engagement metrics like clicks and conversions. Additional examples of the listing insights 128 include content enhancement recommendations to improve descriptions, titles, and visuals, search relevance optimization through keyword or title suggestions, and listing trend analysis to identify emerging listing trends.

The listing insight management system 118, in some instances, generates artificial intelligence data 126, from one or more artificial intelligence models. Examples of the generating of the artificial intelligence data 126 include generating training data for the one or more artificial intelligence models, training the one or more artificial intelligence models (e.g., fine-tuning the one or more artificial intelligence models), configuring a pre-trained artificial intelligence model or selecting a pre-existing artificial intelligence model. Examples of the artificial intelligence data 126 include training data, prompt data, computing resource data, item listing embeddings, hyperparameter configurations, evaluation metrics, synthetic data, augmented data, real-time feedback data, explainability data, and so forth. The item listing embeddings represent item listing attributes, such as price, condition, item category, descriptions, reviews, source, and so forth.

The listing insight management system 118 uses service provider data 122 stored in storage device 120 to manage and generate the listing insights 128, and deploy operations associated with the listing insights 128. The service provider data 122 includes data pertaining to the offerings (e.g., the digital services 112) and operations of the service provider system 102. The service provider data 122 includes the item data 116 pertaining to items, such as items made available by the service provider system 102.

In some examples, the service provider data 122 includes the artificial intelligence data 126 pertaining to artificial intelligence operations of the service provider system 102 (e.g., of the listing insight management system 118), such as training data, prompt data, computing resource data, or one or more artificial intelligence models.

The service provider data 122, in some instances, includes item listing data 124. The item listing data 124 is representative of data pertaining to item listings, such as item listings made available by the service provider system 102, item listings made available by other service provider systems, or item listings made available by online listing platforms. Examples of the item listing data 124 include price data, user sentiment data (e.g., reviews), transaction history data, listing performance metrics (e.g., click-through rates, conversion rates, etc.), listing source data, inventory levels, or metadata related to item categories, attributes, or listing user information.

The listing insight management system 118, in some instances, broadcasts the listing insights 128 to the communication module 108 of the client device 104 for display via the user interface of the client device 104. The components of the service provider system 102 and the client device 104 create a robust framework for generating, deploying, and managing the artificial intelligence services 114 and the listing insights 128.

These components enable scalable, dynamic generation of listing insights with artificial intelligence and ensure the listing insight management system 118 adapts effectively to evolving real-time conditions for items. Further discussion of these and other examples is included in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Generating Listing Insights With Artificial Intelligence

The following discussion describes techniques that are implementable utilizing the previously described systems and devices. Aspects of each of the procedures are implemented in hardware, firmware, software, or a combination thereof. The procedures are shown as a set of blocks that specify operations performed and/or caused by one or more devices and are not necessarily limited to the orders shown for performing the operations by the respective blocks.

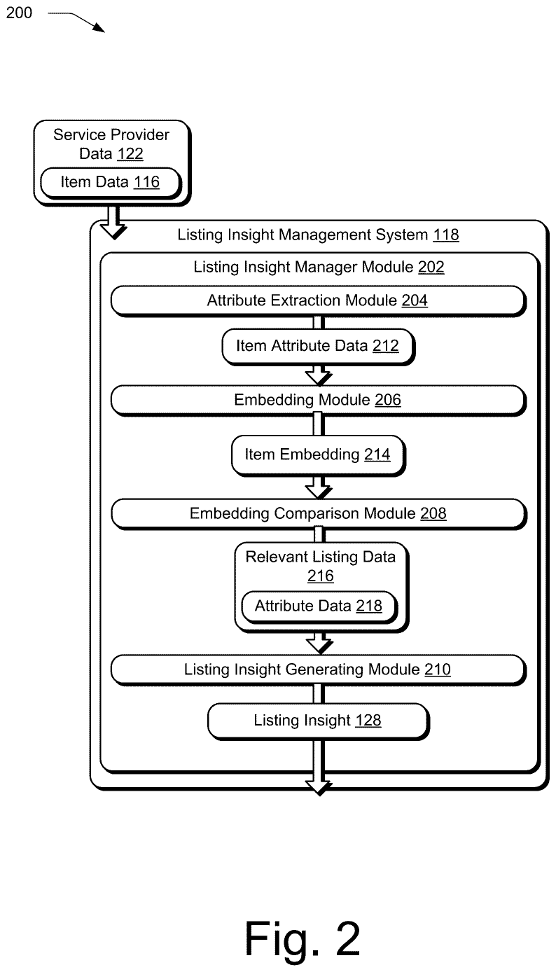

FIG. 2 depicts a system 200 in an example implementation showing operation of the listing insight management system 118 of FIG. 1 in greater detail to generate the listing insight 128. The listing insight management system 118 implemented in this example includes a listing insight manager module 202 including an attribute extraction module 204, an embedding module 206, an embedding comparison module 208, and a listing insight generating module 210. The listing insight manager module 202 is configured to manage operations corresponding to the listing insights 128, examples of which include processing the service provider data 122, processing the item data 116, extracting the item attribute data 212, and generating the item embeddings 214.

The listing insight manager module 202 is illustrated as receiving the service provider data 122, in which the service provider data 122 includes the item data 116 of FIG. 1. The listing insight manager module 202 communicates the service provider data 122 including the item data 116 to the attribute extraction module 204.

To continue this illustrated example system 200, the attribute extraction module 204 receives the service provider data 122 including the item data 116. The attribute extraction module 204 is configured to extract item attributes (e.g., relevant item attributes) from the item data 116 as the item attribute data 212.

Examples of the item attribute data 212 include data such as an item's name, model, category, brand, and edition, which help identify and classify the item, the item's physical characteristics, such as color, size, weight, dimensions, and material composition, the item's technical specifications, such as storage capacity, processing power, or resolution, condition attributes, such as whether the item is new, refurbished, or used, associated metadata, such as manufacturing year or release date, pricing-related data, such as the item's current price, historical prices, and discounts, availability data, such as stock levels or shipping options, descriptive data, such as tags, keywords, or user-provided descriptions, or digital content like images, videos, or audio recordings associated with the item.

Examples of the extraction techniques of the attribute extraction module 204 include natural language processing, computer vision techniques, optical character recognition, schema-mapping techniques, machine learning techniques, or audio processing techniques. The attribute extraction module 204 is configurable in various ways to process the item data to generate or extract the item attribute data 212. In some examples, the attribute extraction module 204 extracts the one or more item attributes (e.g., the item attribute data 212) via a machine learning model trained to identify item attributes such as the item attribute data 212. The attribute extraction module 204 communicates the item attribute data 212 to the embedding module 206.

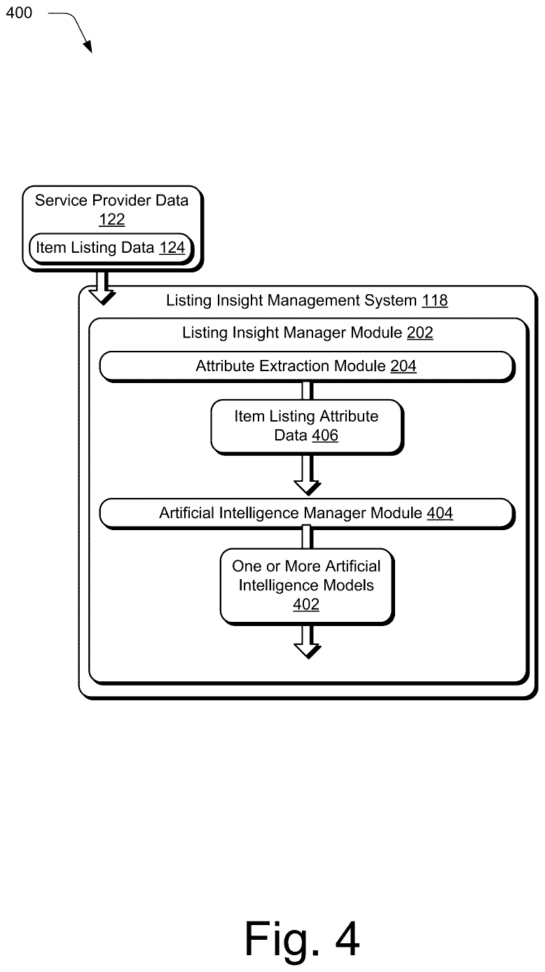

To continue this illustrated example system 200, the embedding module 206 receives the item attribute data 212. The embedding module 206 is configured to generate embeddings for various types of input data, such as the item attribute data 212 or the item listing attribute data 406, which is depicted in FIG. 4. In instances where the embedding module 206 generates the embeddings, the embeddings represent the input data. In some examples, the embeddings are vector representations. In some embodiments, the embedding module 206 uses one or more artificial intelligence models, such as the one or more artificial intelligence models 402 depicted in FIG. 4, as part of the process to generate embeddings. Examples of the one or more artificial intelligence models 402 include large language models, computer vision models, multimodal models, diffusion models, audio processing models, deep embedding networks, and so forth.

As part of the generating of the embeddings, the embedding module 206 is configurable to use various techniques or tools, examples of which include one-hot encoding, embedding layers, word2vec, GloVe, BERT, convolutional neural networks, or multimodal learning models.

In some examples, the embedding module 206 is configured to generate embeddings for a plurality of item listings, wherein each of the plurality of item listings includes the item listing data 124. The embedding module 206 processes the item listing data 124 corresponding to the plurality of item listings to extract one or more of the relevant item listing attributes as the item listing attribute data 406. The embedding module generates representations of the item listing attribute data 406 as the item listing embeddings. The listing insight manager module 202 is configurable to use the item listing embeddings for various operations associated with the listing insights 128, such as relevance scoring, clustering, or trend analysis.

Although the embedding module 206 is configurable to generate embeddings for input data, such as the item listing embeddings for the item listing data 124, the embedding module 206 is illustrated as generating the item embedding 214 based on the item attribute data 212. The embedding module 206 communicates the item embedding 214 to the embedding comparison module 208.

To continue this illustrated example system 200, the embedding comparison module 208 receives the item embedding 214. The embedding comparison module 208 is configured to perform various operations associated with embeddings, examples of which include receiving the item embedding 214, receiving the item listing embeddings, initiating retrieval of listing data (e.g., of the relevant listing data 216) based on one or more embeddings, receiving listing data based on one or more embeddings, receiving the relevant listing data 216 based on one or more embeddings, generating one or more relevance scores for the plurality of item listings wherein the each of the one or more relevance scores represents a relevance between the item embedding and item listing embeddings corresponding to the plurality of item listings, and so forth. The embedding comparison module 208 is configurable to perform the various operations associated with the embeddings at least in part with one or more artificial intelligence models, such as the one or more artificial intelligence models 402 depicted in FIG. 4.

In this illustrated example system 200, based on the item embedding 214, the embedding comparison module 208 generates one or more relevance scores for the plurality of item listings, wherein the each of the one or more relevance scores represents a relevance between the item embedding and the item listing embeddings corresponding to the plurality of item listings. The embedding comparison module 208 initiates retrieval of one or more relevant item listings as the relevant listing data 216, wherein each of the one or more relevant item listings is associated with a relevance score exceeding a threshold amount (e.g., a predefined threshold amount), wherein the each of the one or more relevant item listings includes the attribute data 218 as part of the relevant listing data 216. The relevance scores and the threshold amount are configurable to be expressed in various ways, such as a normalized score, a ranking, a severity, a probability, a percentage, a fraction, semantically, numerically, or so forth. The embedding comparison module 208 produces the relevant listing data 216 including the attribute data 218 and communicates the relevant listing data 216 to the listing insight generating module 210. In some examples, the relevant listing data 216 is real-time data or current data.

To continue this illustrated example system 200, the listing insight generating module 210 receives the relevant listing data 216 including the attribute data 218. The listing insight generating module 210 is configurable to perform various operations associated with generating the listing insight 128, such as generating the listing insight 128 based on the attribute data 218, generating the listing insight 128 for the item, or generating the listing insight 128 for an item listing.

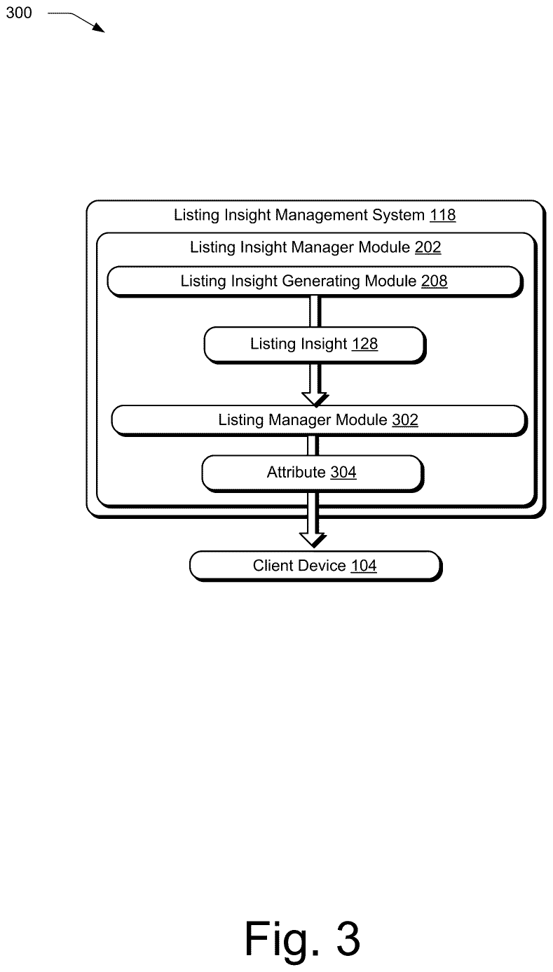

In some embodiments, the listing insight generating module 210 generates the listing insight 128 at least in part with one or more artificial intelligence models. In this illustrated example system 200, the listing insight generating module 210 generates the listing insight 128 based at least in part on the relevant listing data 216 including the attribute data. In some examples, the listing insight generating module 210 communicates or broadcasts the listing insight 128 to the client device 104 for display. In the context of the listing insight management system 118, consider the following discussion of FIG. 3.

FIG. 3 depicts a system 300 in an example implementation showing operation of the listing insight management system 118 of FIGS. 1 and 2, in which the listing insight management system 118 generates a modified listing attribute based on the listing insight 128. As already noted, the illustrated system 300 includes the listing insight management system 118 of FIGS. 1 and 2, in which the listing insight management system 118 includes the listing insight manager module 202 of FIG. 2. The listing insight manager module 202 includes the listing insight generating module 208 of FIG. 2 and a listing manager module 302.

In this illustrated example system 300, the listing insight generating module 208 communicates the listing insight 128 to the listing manager module 302, which is configured to manage operations corresponding to item listings made available by the service provider system 102, examples of which include generating draft item listings based on the listing insight 128, generating the listing insights 128 corresponding to one or more item listings, displaying the listing insights 128 corresponding to the one or more item listings, modifying existing item listings based on the listing insight 128, generating or modifying an attribute 304 associated with a draft or existing item listing based on the listing insight 128, and so forth. The listing manager module 302 receives the listing insight 128.

To continue this illustrated example system 300, the listing manager module 302 generates the attribute 304 (e.g., a price, keyword, etc.) corresponding to an item for an item listing. The listing manager module 302 broadcasts the attribute 304 to the client device 104. In some examples, the listing manager module 302 modifies the attribute 304 of an item listing based on the listing insight 128. As discussed throughout, as with the other operations of the listing insight manager module 202 and its various modules, the operations of the listing manager module 302 are performable, at least in part, via one or more artificial intelligence models. In the context of the listing insight management system 118, consider the following discussion of FIG. 4.

FIG. 4 depicts a system 400 in an example implementation showing operation of the listing insight management system 118 of FIGS. 1 and 2, in which the listing insight management system 118 trains the one or more artificial intelligence models 402 based at least in part on the item listing data 124 of FIG. 1. As already noted, the illustrated system 400 includes the listing insight management system 118 of FIG. 1, in which the listing insight management system 118 includes the attribute extraction module 204 of FIG. 2 and an artificial intelligence manager module 404.

To begin this example of the system 400, the listing insight management system 118 receives the service provider data 122 including the item listing data 124. In some examples, the listing insight management system 118 receives the item listing data 124 via various techniques, examples of which include web scraping, using a web crawler, API integration, advanced data analysis, and so forth. In some embodiments, the listing insight management system 118 receives the item listing data via various techniques, examples of which include receiving the item listing data 124 from a website, receiving the item listing data 124 from a plurality of websites, receiving the item listing data 124 by web scraping one or more websites, receiving the item listing data 124 by web scraping a plurality of websites hosted by different service provider systems, or receiving the item listing data 124 by web scraping a plurality of websites hosted by different servers.

The listing insight management system communicates the service provider data 122 including the item listing data 124 to the attribute extraction module 204. Based on at least the item listing data 124, as discussed throughout, the attribute extraction module 204 generates the item listing attribute data 406. The attribute extraction module 204 communicates the item listing attribute data 406 to the artificial intelligence manager module 404.

To continue this example of system 400, the artificial intelligence manager module 404 receives the item listing attribute data 406. The artificial intelligence manager module 404 is configured to perform operations pertaining to artificial intelligence (e.g., the artificial intelligence data 126 of FIG. 1), examples of which include generating the one or more artificial intelligence models 402, training the one or more artificial intelligence models 402, or deploying the one or more artificial intelligence models 402. The artificial intelligence manager module 404 trains the one or more artificial intelligence models 402.

As part of the training of the one or more artificial intelligence models 402, the artificial intelligence manager module 404 is configurable to perform operations including fine-tuning, applying loss functions (e.g., Mean Squared Error, Mean Absolute Error, Cross-Entropy Loss, etc.), data augmentation, or applying optimization algorithms. In some examples, the artificial intelligence manager module 404 preprocesses the item listing attribute data 406 to ensure it is in a suitable format for the training. Examples of the preprocessing include normalization of numerical attributes, tokenization of textual descriptions, or augmentation of data. In some implementations, the artificial intelligence manager module 404 utilizes frameworks like Hugging Face Transformers or TensorFlow as part of the training.

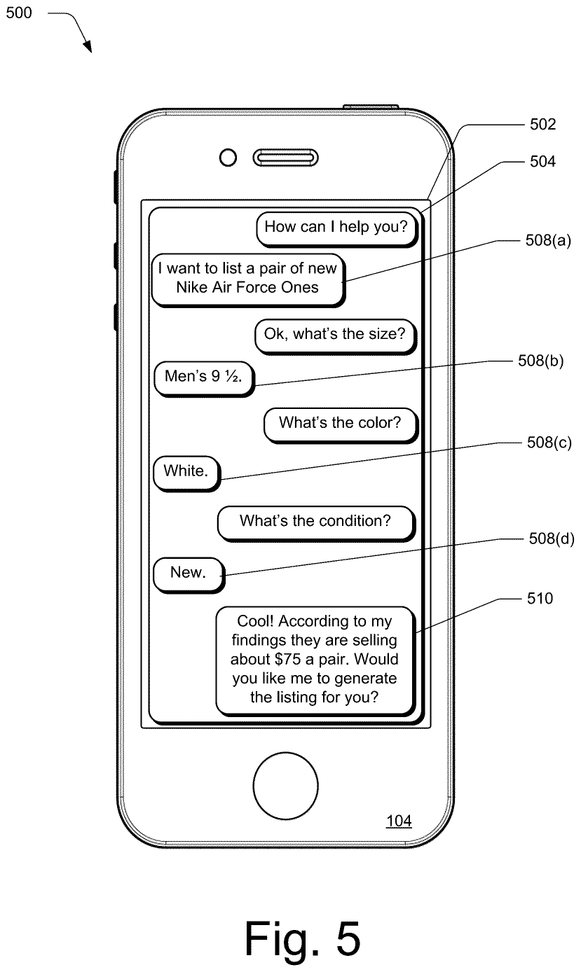

The listing insight management system 118 is configurable to use the one or more artificial intelligence models 402 trained or generated by the artificial intelligence manager module 404 for the various operations performed by the modules of the listing insight management system 118, such as the embedding module 206 or the listing insight generating module 210. In the context of generating the listing insight 128 with one or more artificial intelligence models 402, consider the following discussion of FIG. 5.

FIG. 5 depicts an example implementation 500 of a user interface 502 configured to receive item data 508(a)-(d) via user input and to generate a listing insight 510 based on the item data 508(a)-(d). The user interface 502, as illustrated for the client device 104, depicts a conversation between a user of the service provider system 102 and a chatbot of the service provider system 102.

To continue this illustrated example implementation 500, the chatbot guides the user through the process of providing the item data 508(a)-(d) for a pair of new white Nike Air Force Ones. The user input via the user interface 502 provides responses to a series of questions prompted by the chatbot, providing item details such as the item name (“Nike Air Force Ones”) in 508(a), size (“Men's 9½”) in 508(b), color (“White”) in 508(c), and condition (“New”) in 508(d). Based on the item data 508(a)-(d), the listing insight management system 118 of the service provider system 102 generates the listing insight 510, in this case a price recommendation including an explanation that relevant items (e.g., similar items) are selling for approximately $75 per pair.

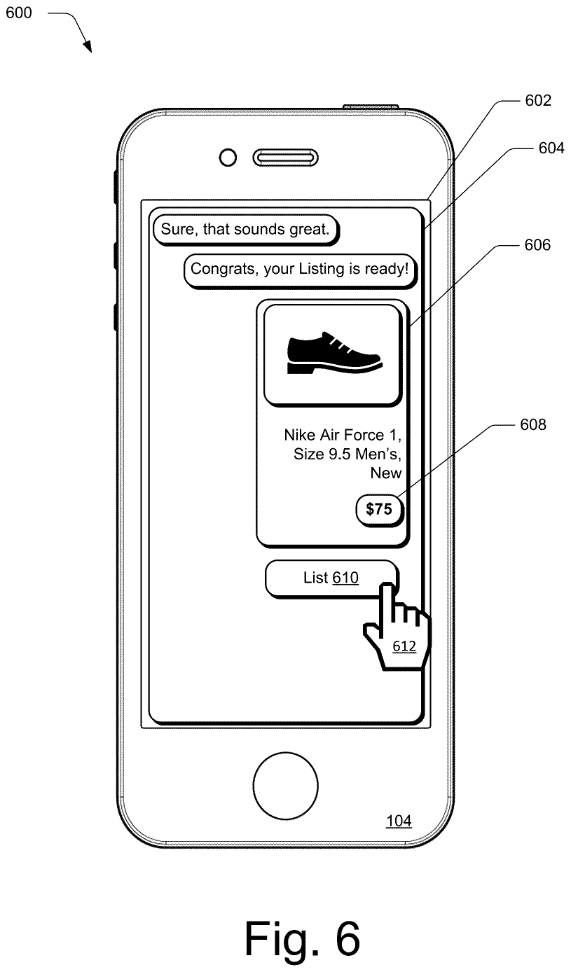

The user interface 502 further offers the user the option to act on the listing insight 510, such as generating an item listing based on the listing insight 510. In some examples, the listing insight management system 118 automatically generates or modifies an item listing based on the listing insight 510, such as generating an item listing including a price of $75 or modifying an existing item listing to include a price of $75. In the context of generating a modified listing attribute based on a listing insight 510 generated with artificial intelligence, consider the following discussion of FIG. 6.

FIG. 6 depicts an example implementation 600 of a user interface 602 configured to generate a modified listing attribute 608 as part of an item listing 606 based on the listing insight 510. In this example, the user interface 602 of the client device 104 displays a confirmation message 604, indicating that the user's item listing has been successfully generated. The item listing 606 generated includes the relevant attributes previously provided by the user, such as the item name (“Nike Air Force 1”), size (“Men's 9.5”), condition (“New”), and the recommended price of $75 as the modified listing attribute 608 based on the listing insight 510.

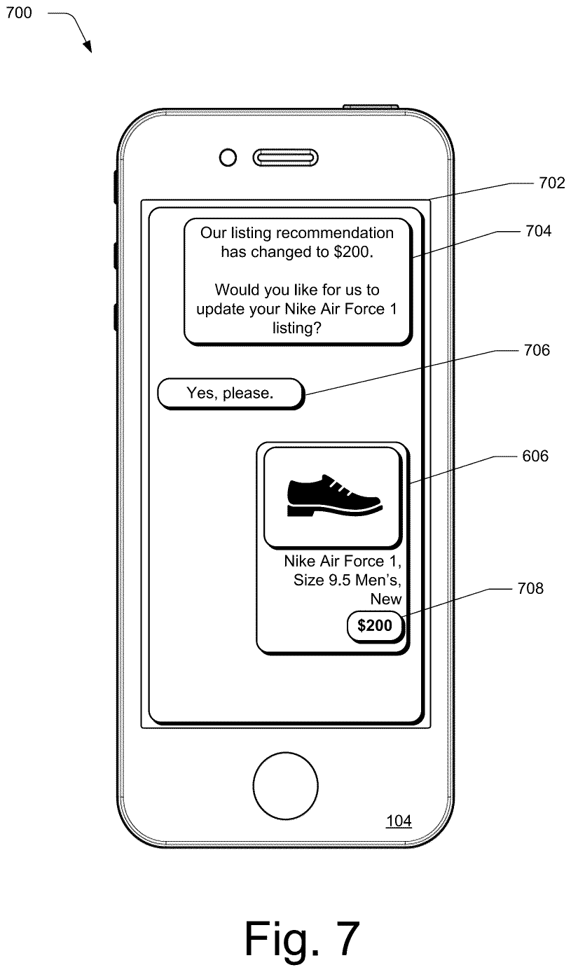

The user interface 602 includes a selectable “List” element 610, which is selectable by the user via user input 612 to make the item listing 606 available via the service provider system 102. Upon selecting the selectable “List” element 610, the client device 104 communicates with the service provider system 102 to list the item listing 606. In the context of generating a listing insight with artificial intelligence, consider the following discussion of FIG. 7.

FIG. 7 depicts an example implementation 700 of a user interface 702 configured to automatically generate a listing insight responsive to detecting a predefined condition. As illustrated, the client device 104 displays a notification message 704 from the chatbot, indicating that the service provider system 102 has detected a predefined condition. As discussed throughout, various predefined conditions are detectable by the service provider system 102, examples of which include detecting a change in item listing conditions, updated listing trends, demand shifts for the item, new relevant item listings on one or more listing platforms, a request for a listing insight, a user-specified trigger, a time-based trigger, a user-engagement trigger, or an inventory trigger.

In this example, the notification message 704 from the chatbot describes that the “listing recommendation has changed to $200”, indicating that a listing insight was generated responsive to detecting the predefined condition. The notification message 704 includes “Would you like for us to update your Nike Air Force 1 listing?”. Responsive to the notification message 704 is a response message 706 provided by the user, indicating, “Yes, please.” Responsive to the confirmation indicated by the response message 706, the item listing 606 of FIG. 6 is updated based on the listing insight generated, with the modified listing attribute 708 reflecting the new price of $200.

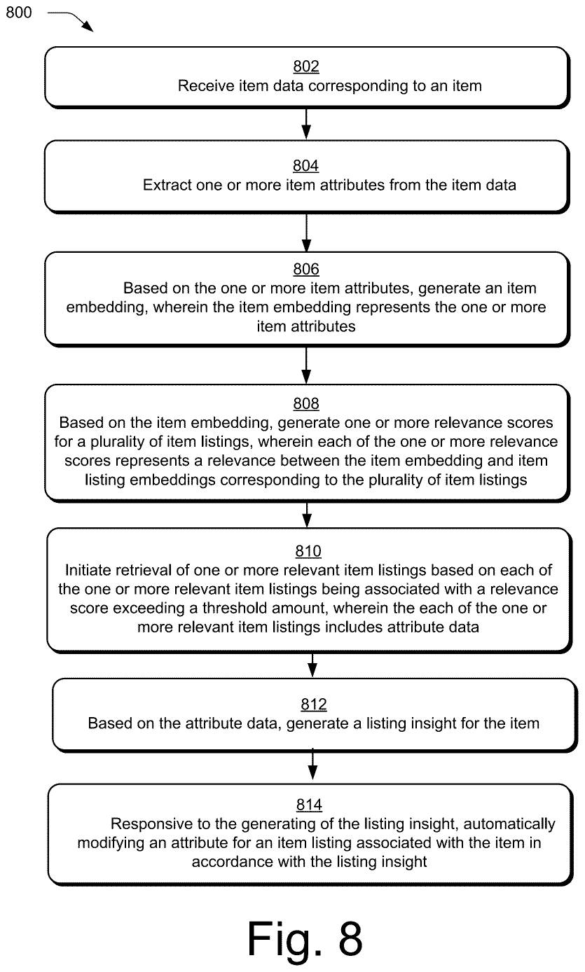

In the context of generating listing insights with artificial intelligence, consider next the following discussion of FIG. 8.

### Example Procedures

The following discussion describes techniques which are implementable utilizing the previously described systems and devices. Aspects of each of the procedures are implementable in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-8.

FIG. 8 depicts a procedure 800 in an example implementation of generating listing insights with artificial intelligence. At block 802, item data 116 corresponding to an item is received. In some examples, the listing insight management system 118 receives the item data 116. In some embodiments, the listing insight management system 118 receives the item data 116 via a listing insight query. The user query is a query initiated by a client device 104 for insights about an item listing. In some examples, the listing insight management system 118 uses an LLM to leverage context from the user query for generating the listing insight 128 via the embedding model. As discussed throughout, examples of the item data 116 include data such as descriptions of the item, digital content (e.g., images, videos, audio, etc.) corresponding to the item, item model, item color, item name, item year, item condition, item age, item price, item owner, and item metadata, item edition, item category, or item specifications.

At block 804, one or more item attributes from the item data 116 is extracted. In some examples, the attribute extraction module 204 of the listing insight manager module 202 extracts one or more item attributes from the item data 116 as the item attribute data 212. As discussed throughout, examples of the item attribute data 212 include data such as an item's name, model, category, brand, and edition, the item's physical characteristics, the item's technical specifications, the item's condition attributes, the item's associated metadata, the item's pricing-related data, the item's availability data, the item's descriptive data, or the item's associated digital content.

At block 806, based on the one or more item attributes, an item embedding 214 is generated, wherein the item embedding 214 represents the one or more item attributes. In some examples, the embedding module 206 of the listing insight management system 118 generates the item embedding 214 based on the item attribute data 212. As discussed throughout, the item embedding 214 represents the item attribute data 212, such as the one or more item attributes.

At block 808, based on the item embedding 214, one or more relevance scores for a plurality of item listings is generated, wherein each of the one or more relevance scores represents a relevance between the item embedding 214 and item listing embeddings corresponding to the plurality of item listings. In some examples, the embedding comparison module 208 generates the one or more relevance scores for a plurality of item listings received as the item listing data 124, wherein each of the one or more relevance scores represents a relevance between the item embedding 214 and item listing embeddings generated by the embedding module 206 based on the item listing attribute data 408 generated by the attribute extraction module 404 based on the item listing data 124. As discussed throughout, the one or more relevance scores are configurable to be expressed in various ways, such as a normalized score, a ranking, a severity, a probability, a percentage, a fraction, semantically, numerically, or so forth.

At block 810, retrieval of one or more relevant item listings is initiated based on each of the one or more relevant item listings being associated with a relevance score exceeding a threshold amount, wherein the each of the one or more relevant item listings includes attribute data 218. In some examples, the embedding comparison module 208 initiates retrieval of the relevant listing data 216 (e.g., the one or more relevant item listings) including the attribute data 218 based on each of the relevant listing data 216 being associated with one or more relevance scores exceeding a threshold amount. As discussed throughout, in some embodiments, the threshold amount is a predefined threshold amount.

At block 812, based on the attribute data 218, a listing insight 128 for the item is generated. In some examples, the listing insight generating module 210 of the listing insight management system 118 generates the listing insight 128. As discussed throughout, examples of the listing insight 128 include performance insights, offering insights for improving engagement metrics like clicks and conversions. Additional examples of the listing insights 128 include content enhancement recommendations to improve descriptions, titles, and visuals, search relevance optimization through keyword or title suggestions, and listing trend analysis to identify emerging listing trends.

At block 814, responsive to the generating of the listing insight 128, an attribute 304 for an item listing associated with the item is automatically modified in accordance with the listing insight 128. In some examples, the listing manager module 302 automatically generates or modifies the attribute 304 for an item listing associated the item in accordance with the listing insight 128. As discussed throughout examples of the attribute include item price, item listing keyword or keywords, item listing title, item listing description, item listing annotations, item listing digital content, item listing shipping details, item listing inventory information, or item listing regional settings. In the context of an example system and device for generating listing insights with artificial intelligence, consider the following discussion of FIG. 9.

### Example System and Device

FIG. 9 illustrates an example system generally at 900 that includes an example computing device 902 that is representative of one or more computing systems and/or devices that implement the various techniques described herein. This is illustrated through inclusion of the listing insight management system 118 and the artificial intelligence service 114. The computing device 902 is configurable, for example, as a server of a service provider, a device associated with a client (e.g., a client device), an on-chip system, and/or any other suitable computing device or computing system.

The example computing device 902 as illustrated includes a processing system 904, one or more computer-readable media 906, and one or more I/O interface 908 that are communicatively coupled, one to another. Although not shown, the computing device 902 further includes a system bus or other data and command transfer system that couples the various components, one to another. A system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that is configurable as processors, functional blocks, and so forth. This includes implementation in hardware as an application specific integrated circuit or other logic device formed using one or more semiconductors. The hardware elements 910 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 906 is illustrated as including memory/storage 912. The memory/storage 912 represents memory/storage capacity associated with one or more computer-readable media. The memory/storage 912 includes volatile media (such as random access memory (RAM)) and/or nonvolatile media (such as read only memory (ROM), Flash memory, optical disks, magnetic disks, and so forth). The memory/storage 912 includes fixed media (e.g., RAM, ROM, a fixed hard drive, and so on) as well as removable media (e.g., Flash memory, a removable hard drive, an optical disc, and so forth). The computer-readable media 906 is configurable in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 902. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer. “Computer-readable signal media” refers to a signal-bearing medium that is configured to transmit instructions to the hardware of the computing device 902, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that are employed in some examples to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 910. The computing device 902 is configured to implement particular instructions and/or functions corresponding to the software and/or hardware modules. Accordingly, implementation of a module that is executable by the computing device 902 as software is achieved at least partially in hardware, e.g., through use of computer-readable storage media and/or hardware elements 910 of the processing system 904. The instructions and/or functions are executable/operable by one or more articles of manufacture (for example, one or more computing devices and/or processing systems 904) to implement techniques, modules, and examples described herein.

The techniques described herein are supported by various configurations of the computing device 902 and are not limited to the specific examples of the techniques described herein. This functionality is also implementable through use of a distributed system, such as over a “cloud” 914 via a platform 916 as described below.

The cloud 914 includes and/or is representative of a platform 916 for resources 918. The platform 916 abstracts underlying functionality of hardware (e.g., servers) and software resources of the cloud 914. The resources 918 include applications and/or data that can be utilized while computer processing is executed on servers that are remote from the computing device 902. Resources 918 can also include services provided over the Internet and/or through a subscriber network, such as a cellular or Wi-Fi network.

The platform 916 abstracts resources and functions to connect the computing device 902 with other computing devices. The platform 916 also serves to abstract scaling of resources to provide a corresponding level of scale to encountered demand for the resources 918 that are implemented via the platform 916. Accordingly, in an interconnected device example, implementation of functionality described herein is distributable throughout the system 900. For example, the functionality is implementable in part on the computing device 902 as well as via the platform 916 that abstracts the functionality of the cloud 914.

What is claimed is:

1. A computer-implemented method, comprising:
receiving item data corresponding to an item for an online listing;
extracting one or more item attributes from the item data;
based on the one or more item attributes, generating an item embedding, wherein the item embedding is a representation of the one or more item attributes;
based on the item embedding, generating one or more similarity scores for a plurality of item listings, wherein each of the one or more similarity scores is representative of a similarity between the item embedding and item listing embeddings corresponding to the plurality of item listings;
initiating retrieval of one or more relevant item listings including item attribute data based on each of the one or more relevant item listings being associated with a similarity score of the one or more similarity scores exceeding a threshold amount;
based on the item attribute data, generating a listing insight for the item; and
broadcasting the listing insight for the item for display.

2. The computer-implemented method of claim 1, wherein the receiving of the item data is via a user query.

3. The computer-implemented method of claim 1, wherein the item data includes at least one keyword, digital content of the item, or description of the item.

4. The computer-implemented method of claim 1, wherein the one or more item attributes include at least one of an item type, model type, item condition, or an item age.

5. The computer-implemented method of claim 1, wherein the item attribute data includes price data, the listing insight includes a price recommendation, and the attribute for the item listing is a price for the item listing.

6. The computer-implemented method of claim 1, further comprising:
receiving the plurality of item listings, wherein each of the plurality of item listings includes item listing data;
extracting one or more item attributes from the item listing data; and
based on the one or more item attributes, generating, for each of the plurality of item listings, one of the item listing embeddings.

7. The computer-implemented method of claim 6, wherein the plurality of item listings is received via web scraping.

8. The computer-implemented method of claim 1, wherein the plurality of item listings is from a plurality of platforms.

9. The computer-implemented method of claim 1, wherein the generating of the item embedding, the generating of the one or more similarity scores, and the generating of the listing insight are via one or more artificial intelligence models.

10. The computer-implemented method of claim 9, wherein one of the one or more artificial intelligence models is a large language model.

11. The computer-implemented method of claim 1, wherein the one or more item attributes are extracted via a machine learning model trained to identify item attributes.

12. The computer-implemented method of claim 1, wherein the listing insight includes an explanation for a recommendation included as part of the listing insight.

13. The computer-implemented method of claim 1, further comprising, broadcasting the listing insight for display.

14. A system comprising:
a memory component; and
a processing device coupled to the memory component, the processing device to perform operations comprising:
receiving item listing data corresponding to a plurality of item listings associated with an item;
extracting, for each one of the plurality of item listings, one or more item listing attributes from the item listing data;
based on the one or more item listing attributes, training one or more artificial intelligence models for generating listing insights for items;
detecting a predefined condition corresponding to triggering generating of a listing insight for an item;
responsive to the detecting, generating the listing insight at least in part via the one or more artificial intelligence models; and
broadcasting the listing insight for display.

15. The system of claim 14, wherein the predefined condition is one of a request for a price insight, a user-specified trigger, a time-based trigger, a user-engagement trigger, or an inventory trigger.

16. The system of claim 14, wherein the training of at least one of the one or more artificial intelligence models includes fine-tuning.

17. The system of claim 14, wherein the one or more item listing attributes include item listing descriptions, item listing digital content, item brand, item color, item model, item year, item condition, item price history, item listing platform identifier, item listing data source, item region, item listing user reviews, or item price.

18. The system of claim 14, wherein the training of at least one of the one or more artificial intelligence models includes using one or more loss functions.

19. The system of claim 18, wherein the one or more loss functions include at least one of a mean squared error or a mean absolute error.

20. A non-transitory computer-readable storage medium storing executable instructions, which when executed by a processing device, cause the processing device to perform operations comprising:
receiving item data corresponding to an item for an online listing;
extracting one or more item attributes from the item data;
based on the one or more item attributes, generating an item embedding, wherein the item embedding is a representation of the extracted item attributes;
based on the item embedding, generating one or more relevance scores for a plurality of item listings, wherein each of the one or more relevance scores is representative of a relevance between the item embedding and item listing embeddings corresponding to the plurality of item listings;
initiating retrieval of one or more relevant item listings including pricing data based each of the one or more relevant item listings having a relevance score exceeding a threshold amount;
based on the pricing data, generating a price recommendation for the item; and
broadcasting the price recommendation for the item for display.
